(19) United States
(12) Patent Application Publication
(10) Pub. No.: US 2015/0286086 A1
(43) Pub. Date: Oct. 8, 2015

(54) DISPLAY DEVICE

(71) Applicant: SHARP KABUSHIKI KAISHA, Osaka (JP)

(72) Inventors: Ryuzo Yuki, Osaka (JP); Takeshi Ishida, Osaka (JP); Hisashi Watanabe, Osaka (JP)

(73) Assignee: Sharp Kabushiki Kaisha, Osaka (JP)

(21) Appl. No.: 14/435,223

(22) PCT Filed: Sep. 25, 2013
(86) PCT No.: PCT/JP2013/075834

§ 371 Date: Apr. 13, 2015

(30) Foreign Application Priority Data
Oct. 26, 2012 (JP) 2012-236346

(51) Int. Cl. G02F 1/1333; G02F 1/1335

(52) U.S. Cl. CPC G02F 1/133308; G02F 1/133608; G02F 2001/133331; G02F 2001/133314; G02F 2001/133322

(57) ABSTRACT

A display device includes a display panel, a backlight that illuminates the display panel from a back surface thereof, a chassis having a recess with an opened front surface, and a transparent member that covers the recess. The display panel and the backlight are fitted into the recess and positioned within a plane parallel to a display surface of the display panel, and the display panel and the backlight are positioned in a direction perpendicular to the display surface by a bottom surface of the recess and the transparent member.

### TECHNICAL FIELD

The present invention relates to a display device having a backlight and a display panel.

### BACKGROUND ART

A conventional display device is disclosed in Patent Document 1. In this display device, a backlight is disposed on a back surface of a display panel. The backlight is accommodated within a metallic case whose top is opened, and the display panel is fixed onto the backlight by a double-sided adhesive tape disposed on a peripheral portion of the top of the backlight. The display panel is illuminated from the back surface by light emitted from the backlight, and an image is displayed in a display region of the display panel.

### RELATED ART DOCUMENT

### Patent Document

Patent Document 1: Japanese Patent Application Laid-Open Publication No. 2011-76101 (pages 7 to 13, FIG. 2)

### SUMMARY OF THE INVENTION

### Problems to be Solved by the Invention

A frame region that blocks light is formed on the periphery of the display region of the display panel. The double-sided adhesive tape that adheres the display panel and the backlight together is covered by the frame region of the display panel, and thus an inner circumferential edge of the double-sided adhesive tape cannot be perceived when viewed from the front of the display region.

At this time, when viewing the display region from a diagonal direction normal to a display surface of the display panel, if an inner edge of the double-sided adhesive tape that shields light is perceived, the display quality of the display device will decrease. Therefore, in order to ensure the display quality of the display device within a predetermined angle range relative to the line normal to the display surface, a predetermined amount of difference between a width of the frame region of the display panel and a width of the double-sided adhesive tape is provided. For example, in order to ensure the display quality in a range of 30° normal to the display surface, the width of the frame of the display panel is formed to be about 0.4 mm greater than the width of the double-sided adhesive tape.

Display devices are used in mobile terminal devices and the like, and thus there is a strong need to reduce the thickness and reduce the width of the frame so as to narrow a space surrounding the display region. However, in the above-described conventional display device, there has been a problem in that if the width of the frame of the display panel is reduced, it becomes difficult to form a double-sided adhesive tape having an even smaller width, and thus the manufacturing workload increases.

Further, there has also been a problem in that, since the machining limit for the width of double-sided adhesive tape is about 0.5 mm, the width of the frame of the display panel must be set to about 0.9 mm in order to maintain display quality, and thus it is difficult to reduce the width of the frame of the display device.

An object of the present invention is to provide a display device in which the manufacturing workload can be reduced and the frame thickness can be reduced without any decreases in the display quality.

### Means for Solving the Problems

In order to achieve the above-mentioned object, a display device of the present invention includes: a display panel; a backlight that illuminates the display panel from a back surface thereof; a chassis having an opened front surface defining a recess therein; and a transparent member that covers the recess in the chassis, wherein the display panel and the backlight are accommodated within the recess, wherein the display panel and the backlight are positioned within respective planes parallel to a display surface of the display panel by being fitted into the recess, and wherein the display panel and the backlight are positioned in a direction perpendicular to the display surface of the display panel by a bottom surface of the recess and the transparent member.

According to the above configuration, the backlight and the display panel are fitted into the recess provided in the chassis, and are thus accommodated upon being positioned within a plane parallel to the display surface. Also, the backlight and the display panel are sandwiched between the bottom surface of the recess and the transparent member disposed on the chassis, and are thereby positioned in a direction perpendicular to the display surface.

In the display device of the present invention configured as described above, when the display surface is disposed facing upwards, the backlight contacts the bottom surface of the recess, the display panel contacts a top of the backlight, and a bottom of the transparent member is near or in contact with the display panel.

In the display device of the present invention configured as described above, the recess in the chassis has a stepped portion that is narrow on a back surface side thereof, the backlight is fitted to a lower level of the stepped portion, and the display panel is fitted to an upper level of the stepped portion.

In the display device of the present invention configured as described above, the recess in the chassis has the bottom surface thereof open, and has mounting portions that project from inner peripheral walls thereof, and the backlight includes a reflective sheet that is bridged between the opposing mounting portions.

In the display device of the present invention configured as described above, the recess has, in a back surface side thereof, a substrate accommodating area that accommodates a circuit substrate for the display panel, and, in the bottom surface thereof, an insertion hole for a lead wire that connects the display panel to the circuit substrate.

### Effects of the Invention

According to the present invention, the display panel and the backlight are fitted into the recess in the chassis and are thereby positioned within a plane parallel to the display surface, and the display panel and the backlight are positioned in a direction perpendicular to the display surface by the bottom surface of the recess and the transparent member. Therefore, the double-sided adhesive tape that bonds the display panel and the backlight together in the conventional example can be eliminated. Thus, the manufacturing workload of the display device can be reduced and the frame thickness can be reduced while maintaining display quality.

### BRIEF DESCRIPTION OF THE DRAWINGS

FIG. 1 is an exploded perspective view showing a display device according to Embodiment 1 of the present invention.

FIG. 2 is a side surface cross-sectional view showing the display device according to Embodiment 1 of the present invention.

FIG. 3 is a front surface cross-sectional view showing the display device according to Embodiment 1 of the present invention.

FIG. 4 is a front surface cross-sectional view showing the details of a junction of a transparent member of the display device according to Embodiment 1 of the present invention.

FIG. 5 is a front surface cross-sectional view showing the details of another junction of the transparent member of the display device according to Embodiment 1 of the present invention.

FIG. 6 is a front surface cross-sectional view showing the details of another junction of the transparent member of the display device according to Embodiment 1 of the present invention.

FIG. 7 is a front surface cross-sectional view showing the details of another junction of the transparent member of the display device according to Embodiment 1 of the present invention.

FIG. 8 is a side surface cross-sectional view showing a display device according to Embodiment 2 of the present invention.

FIG. 9 is a front surface cross-sectional view showing a display device according to Embodiment 3 of the present invention.

FIG. 10 is a side surface cross-sectional view showing a display device according to Embodiment 4 of the present invention.

### DETAILED DESCRIPTION OF EMBODIMENTS

### Embodiment 1

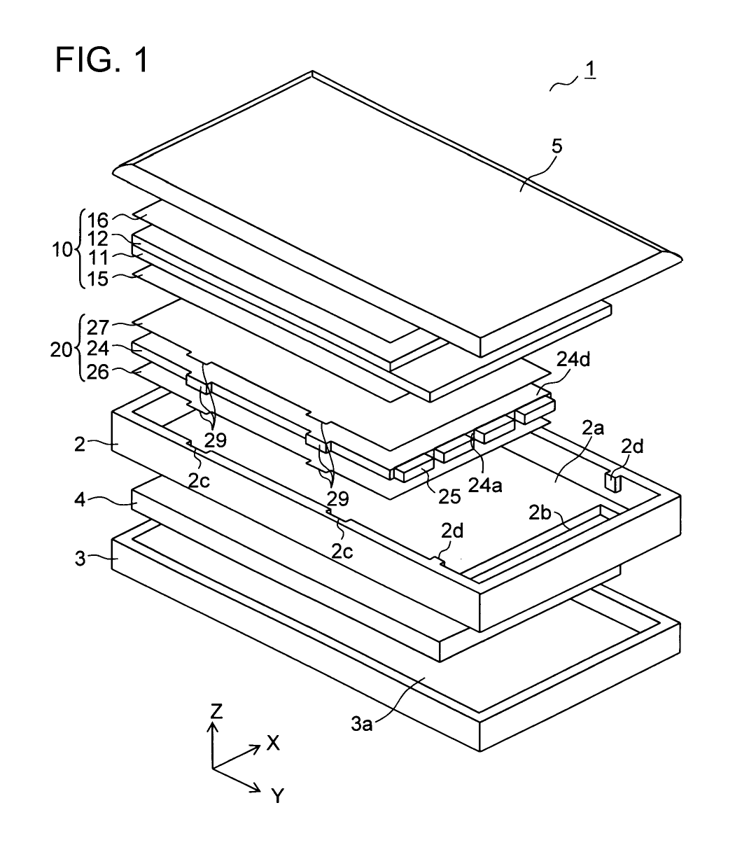

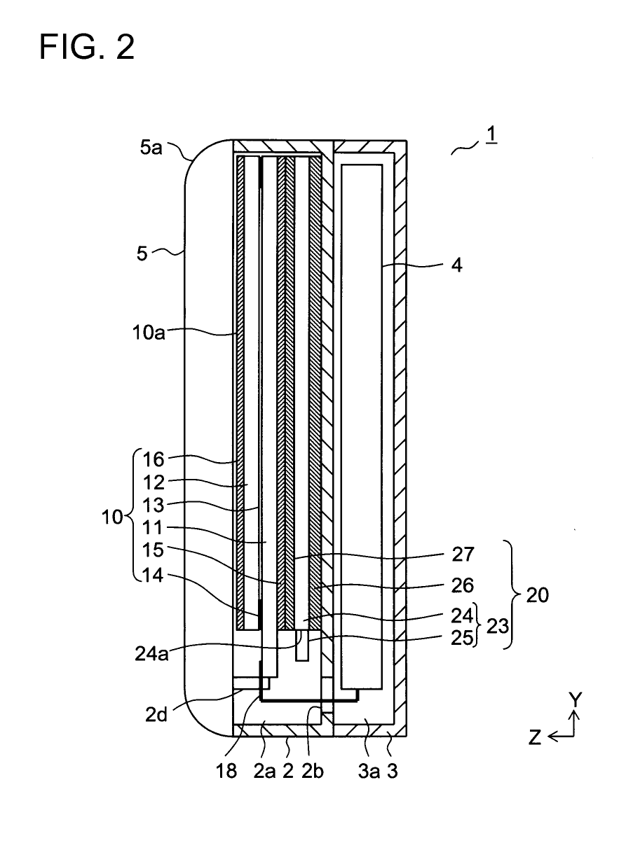

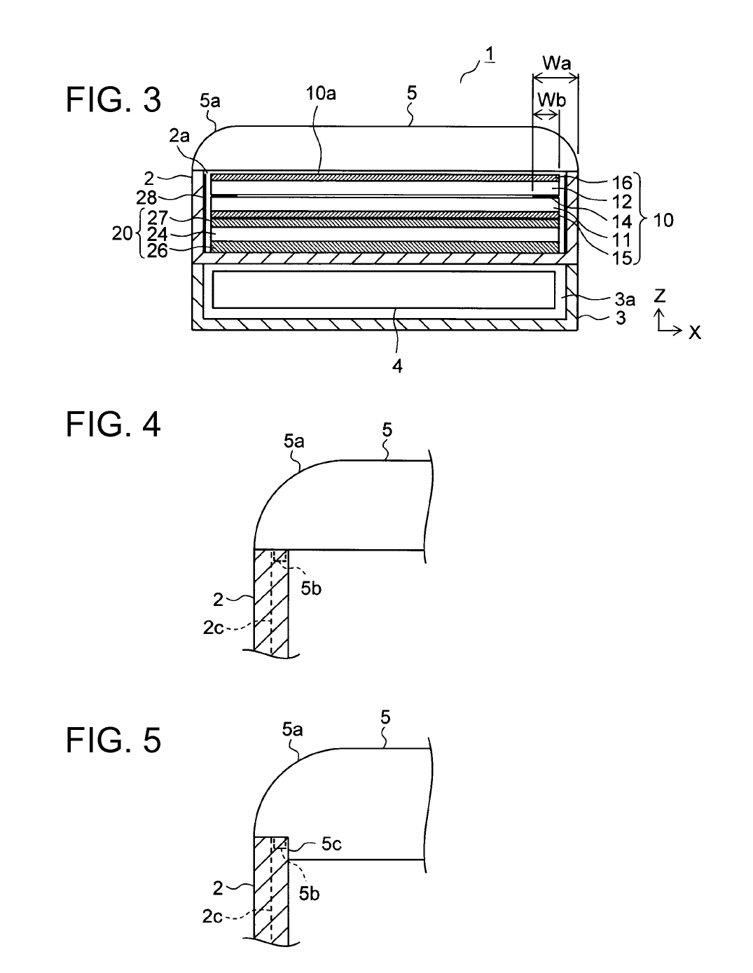

Embodiments of the present invention will be explained below with reference to figures. FIGS. 1, 2, and 3 are an exploded perspective view, a side surface cross-sectional view, and a front surface cross-sectional view showing a display device according to Embodiment 1. A display device 1 is retained by an upper chassis 2 and a lower chassis 3 that form an outer peripheral surface of a mobile terminal device or the like. The upper chassis 2 and the lower chassis 3 are adhered together by double-sided adhesive tape (not illustrated) or the like.

A substrate accommodating portion 3a having an opened top is opened is formed in the lower chassis 3, and a circuit substrate 4 and a battery (not illustrated) or the like are accommodated within the substrate accommodating portion 3a. A recess 2a whose top is opened is formed in the upper chassis 2, and a display panel 10 and a backlight 20, which have a rectangular shape in a plan view, are accommodated within the recess 2a. A transparent member 5 is disposed on the upper chassis 2. A display surface 10a is formed on top of the display panel 10 opposing the transparent member 5.

In the following explanation, a shorter dimension direction of the display panel 10 and the backlight 20 that are parallel to the display surface 10a will be referred to as an X direction, a direction orthogonal to the X direction within a plane parallel to the display surface 10a will be referred to as a Y direction, and a direction perpendicular to the display surface 10a will be referred to as a Z direction.

An insertion hole 2b facing the substrate accommodating portion 3a is provided in one end on a bottom surface of the recess 2a of the upper chassis 2. A plurality of fitting grooves 2c are formed on both side walls opposing each other in the X direction of the recess 2a. The fitting grooves 2c are disposed to be asymmetrical relative to a center line that is orthogonal to a light-receiving face 24a of a light guide plate 24 to be explained later. Ribs 2d are provided to project from an upper portion on both side walls opposing each other in the X direction near the insertion hole 2b of the recess 2a.

Further, the inner walls of the recess 2a are subjected to a high-reflectance treatment by forming a reflective layer 28. The reflective layer 28 is formed by sputtering or plating a thin film of aluminum, silver, or the like on the upper chassis 2. The reflective layer 28 may also be formed by printing with white ink. Also, the upper chassis 2 may be formed by metal and subjected to a high-reflectance treatment by mirror finishing. Light that has leaked from the light guide plate 24 or an optical sheet 27 (explained later) is reflected by the reflective layer 28 (high-reflectance treatment), and thus the light utilization efficiency can be improved and the luminance of light can be increased.

The display panel 10 is formed by a liquid crystal panel or the like, and therein a pixel substrate 11 having pixel electrodes and an opposite substrate 12 having an opposite electrode are disposed opposing each other. Liquid crystal 13 is sealed by a seal 14 disposed on a peripheral part between the pixel substrate 11 and the opposite substrate 12. A width Wa of a frame of the display panel 10 is determined by a width Wb of the seal 14 and a thickness of the upper chassis 2.

The pixel substrate 11 and the opposite substrate 12 are connected to the circuit substrate 4 via a lead wire 18 made of an FPC that is inserted into the insertion hole 2b in the bottom surface of the recess 2a. Optical sheets 15 and 16 made of a polarizing plate, a retardation film, or the like are adhered respectively to the back surface of the pixel substrate 11 and the top of the opposite substrate 12.

The backlight 20 is disposed on the back surface side of the display panel 10, and is an edge-lit type in which a light source 25 is disposed opposing the peripheral face of the thin plate-shaped light guide plate 24. The light source 25 is made of a plurality of LEDs, and opposes the light-receiving face 24a made of one peripheral face in the shorter direction of the light guide plate 24 that is formed in a rectangular shape. Light that has entered from the light-receiving face 24a is guided through the light guide plate 24, and is emitted from a light-exiting surface surface 24d on the top of the light guide plate 24. In this manner, the display panel 10 is illuminated from the back surface thereof, and an image is displayed on the display surface 10a. The light-receiving face 24a may be formed on two opposing sides of the light guide plate 24 and light sources 25 may be disposed opposing both light-receiving faces 24a.

The light guide plate 24 and the light source 25 form a light guide plate assembly 23 that is integrated by a retaining member (not illustrated). The light source 25 is connected to the circuit substrate 4 via a lead wire (not illustrated). Also, a reflective sheet 26 is disposed on the back surface of the light guide plate 24, and one or a plurality of optical sheets 27 formed by a diffusion sheet, a prism sheet, or the like are formed on the top of the light guide plate 24.

The reflective sheet 26 and the optical sheets 27 are formed in a planar shape that is substantially identical to the shape of the light guide plate 24. Projections 29 that fit into the fitting grooves 2c are provided to project from the peripheral face of the light guide plate 24, the reflective sheet 26, and the optical sheets 27. The reflective sheet 26 and the optical sheets 27 may be adhered to the light guide plate 24 by double-sided adhesive tape disposed on the projections 29.

The reflective sheet 26, the light guide plate assembly 23, and the optical sheets 27 that constitute the backlight 20 are stacked in order and accommodated within the recess 2a. At this time, the reflective sheet 26, the light guide plate assembly 23, and the optical sheets 27 are positioned in the X direction by the inner walls of the recess 2a and positioned in the Y direction by the fitting grooves 2c. In other words, the backlight 20 is fitted into the recess 2a and thereby positioned within a plane parallel to the display surface 10a.

At this time, the fitting grooves 2c and the projections 29 are disposed asymmetrically relative to a center line that is orthogonal to the light-receiving face 24a of the light guide plate 24. Therefore, erroneous insertion of the light guide plate assembly 23, the reflective sheet 26, and the optical sheets 27 with an incorrect orientation such as a being flipped over is prevented. Accordingly, the assembly of the display device 1 can be facilitated, and thus the yield can be improved and the costs reduced.

Also, the display panel 10 in which the optical sheet 15, the pixel substrate 11, the opposite substrate 12, and the optical sheet 16 are integrated is similarly placed on the backlight 20 and accommodated within the recess 2a. At this time, the pixel substrate 11 of the display panel 10 is positioned in the X direction by the inner walls of the recess 2a and positioned in the Y direction by one inner wall in the Y direction of the recess 2a and the ribs 2d. In other words, the display panel 10 is fitted into the recess 2a and thereby positioned within a plane parallel to the display surface 10a.

The backlight 20 may be positioned in the Y direction by ribs provided to project from the recess 2a. Projections that fit into the fitting grooves 2c may also be provided to a side surface of the pixel substrate 11 or the opposite substrate 12 or a side surface of the optical sheets 15 and 16 in order to position the display panel 10 in the Y direction.

The transparent member 5 is formed by a resin, glass, or the like, and is disposed on a top end of the upper chassis 2 to cover the recess 2a. In a junction of the transparent member 5 and the upper chassis 2, as shown in FIG. 4, a projection 5b that fits into the fitting groove 2c is provided on a bottom on a periphery of the transparent member 5, and the transparent member 5 is thereby secured upon being positioned. The display panel 10 and the backlight 20 are positioned in a direction perpendicular to the display surface 10a (the Z direction) by the bottom surface of the recess 2a and the transparent member 5.

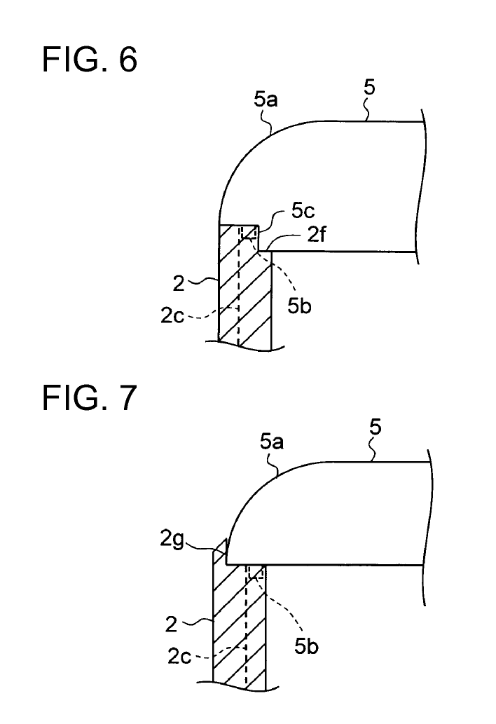

As shown in FIG. 5, a stepped portion 5c whose outer peripheral side is recessed may be formed on a periphery of a bottom of the transparent member 5. At this time, the transparent member 5 is disposed so that a wall surface of the upper chassis 2 fits in the stepped portion 5c. Also, as shown in FIG. 6, the stepped portion 5c whose outer peripheral side is recessed may be formed on the periphery of the bottom of the transparent member 5 and a stepped portion 2f whose inner peripheral surface is recessed may be formed on a wall surface of the upper chassis 2. At this time, the wall surface of the upper chassis 2 fits in the stepped portion 5c and the transparent member 5 is disposed on a bottom surface of the stepped portion 2f. Further, as shown in FIG. 7, a stepped portion 2g whose inner peripheral surface is recessed may be formed on a wall surface of the upper chassis 2. At this time, the transparent member 5 is fitted to the peripheral surface of the stepped portion 2g and disposed on the bottom surface of the stepped portion 2g.

A curved surface 5a is formed on a periphery of the top of the transparent member 5. In this manner, light refracts at the curved surface 5a of the transparent member 5 when viewing the display device 1 from the front surface, and thus a frame that is narrower than the actual frame width Wa is perceived. A thickness t of the transparent member 5 and a curvature radius r of the curved surface 5a preferably have the relationships shown in formulas (1) and (2) below, in which Wa is the frame width of the display device 1.

t=2.7Wa˜4.6Wa (1)

r=1.6Wa˜4.2Wa (2)

Gaps in the X direction and the Y direction between the display panel 10/backlight 20 and the recess 2a are formed to be, for example, approximately several dozen μm. Also, when disposing the display surface 10a facing upwards, a gap in the Z direction between the bottom of the transparent member 5 and the display panel 10 is formed to be, for example, approximately several dozen pm, so that the bottom of the transparent member 5 is near the display panel 10.

Thus, the display panel 10 and the backlight 20 are disposed such that they can move within the range of the gaps in the recess 2a. At this time, by forming an emitting region of light from the backlight 20 to be larger by a predetermined amount than a display region of the display panel 10, reductions in the display quality of the display device 1 can be prevented.

The display panel 10 and the backlight 20 may be adhered in the recess 2a by an adhesive injected into the recess 2a. The transparent member 5 and the display panel 10 may also be in contact such that the display panel 10 and the backlight 20 are sandwiched by the transparent member 5 and the bottom surface of the recess 2a. In this manner, the display panel 10 and the backlight 20 can be prevented from sliding.

According to the present embodiment, the display panel 10 and the backlight 20 are fitted into the recess 2a of the upper chassis 2 and thereby positioned in the X and Y directions within a plane parallel to the display surface 10a, and positioned in a direction perpendicular to the display surface 10a (the Z direction) by the bottom surface of the recess 2a and the transparent member 5. This makes it possible for the double-sided adhesive tape that bonds the display panel 10 and the backlight 20 together in the conventional example to be eliminated. Thus, the manufacturing workload of the display device 1 can be reduced and the frame thickness can be reduced while maintaining display quality.

Furthermore, when disposing the display surface 10a facing upwards, the backlight 20 contacts the bottom surface of the recess 2a and the display panel 10 contacts the top of the backlight 20, and a bottom of the transparent member 5 is near or in contact with the display panel 10. This allows the light guide plate assembly 23 and the like that constitute the backlight 20 and the display panel 10 to be stacked in order so that the display device 1 can be easily formed.

Further, the substrate accommodating portion 3a that accommodates the circuit substrate 4 is provided on a back surface side of the recess 2a, and the insertion hole 2b of the lead wire 18 is provided on the bottom surface of the recess 2a. Therefore, the lead wire 18 can be shortened and the display panel 10 and the circuit substrate 4 can be easily connected to each other.

### Embodiment 2

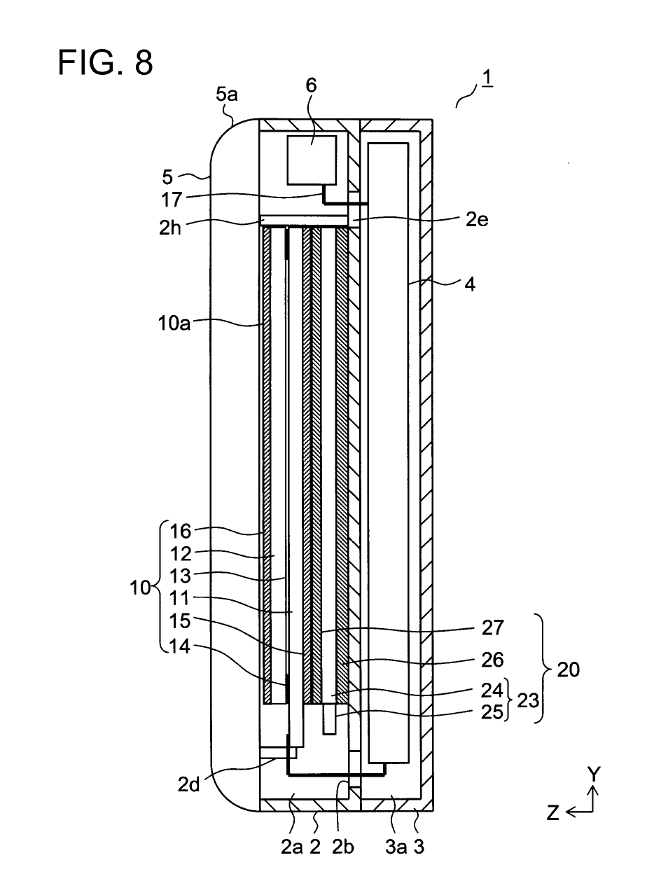

Next, FIG. 8 shows a side surface cross-sectional view of a display device 1 according to Embodiment 2. For the sake of explanation, portions that are identical to those in Embodiment 1 shown in FIGS. 1 to 7 will be assigned the same reference characters. In the present embodiment, an imaging element 6 such as a CCD that images an object is disposed within the upper chassis 2. The other portions are identical to Embodiment 1.

An insertion hole 2e is provided on an end on the opposite side of the insertion hole 2b in the bottom surface of the recess 2a of the upper chassis 2. Ribs 2h are provided to project from both side walls opposing each other in the X direction near the insertion hole 2e of the recess 2a. The imaging element 6 is disposed on an outer peripheral side of the ribs 2h, and the imaging element 6 is connected to the circuit substrate 4 via a lead wire 17 made of an FPC that is inserted into the insertion hole 2e. The backlight 20 and the display panel 10 are disposed more toward the inner peripheral side than the ribs 2h, and the pixel substrate 11 of the display panel 10 is fitted between the ribs 2h and the ribs 2d positioned in the Y direction. Thus, an effect that is similar to that of Embodiment 1 can be achieved.

### Embodiment 3

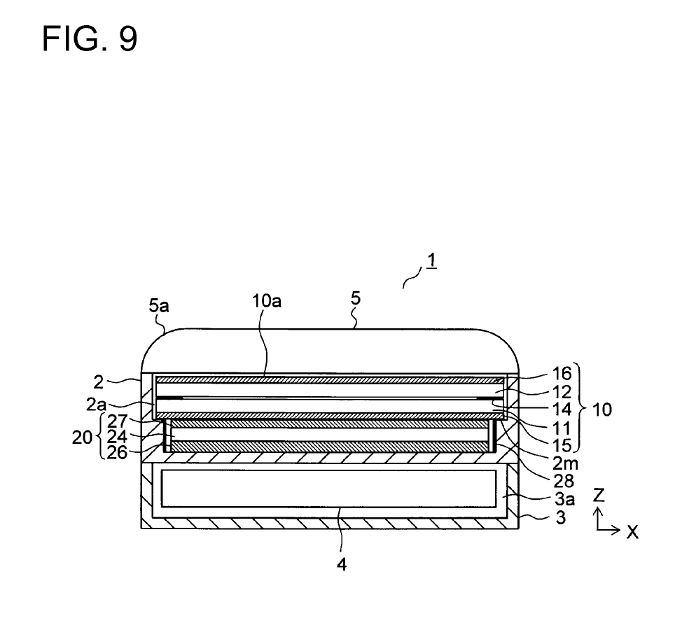

Next, FIG. 9 shows a side surface cross-sectional view of a display device 1 according to Embodiment 3. For the sake of explanation, portions that are identical to those in Embodiment 1 shown in FIGS. 1 to 7 will be assigned the same reference characters. In the present embodiment, a stepped portion 2m is provided within the recess 2a of the upper chassis 2. The other portions are identical to Embodiment 1.

In the upper chassis 2, the thickness of a lower part of the recess 2a is formed to be thicker than that of an upper part, and a stepped portion 2m whose lower portion is narrow is formed within the recess 2a. A plurality of fitting grooves 2c (refer to FIG. 1) are also formed across the upper and lower steps of the stepped portion 2m on both side walls opposing each other in the X direction of the recess 2a. The backlight 20 is disposed on the lower step of the stepped portion 2m, and the display panel 10 is placed on a horizontal surface of the stepped portion 2m so as to be disposed on the upper step of the stepped portion 2m.

At this time, the reflective sheet 26, the light guide plate assembly 23, and the optical sheets 27 that constitute the backlight 20 are positioned in the X direction by the inner walls of the lower step of the stepped portion 2m and positioned in the Y direction by the fitting grooves 2c. In other words, the backlight 20 is fitted in the recess 2a and thereby positioned within a plane parallel to the display surface 10a.

Furthermore, the pixel substrate 11 of the display panel 10 is positioned in the X direction by the inner walls of the upper step of the stepped portion 2m and positioned in the Y direction by one inner wall in the Y direction of the recess 2a and the ribs 2d. In other words, the display panel 10 is fitted into the recess 2a and thereby positioned within a plane parallel to the display surface 10a.

Further, the display panel 10 and the backlight 20 are positioned in a direction perpendicular to the display surface 10a (the Z direction) by the bottom surface of the recess 2a and the transparent member 5. At this time, the optical sheet 16 on the top of the display panel 10 may contact or be near the transparent member 5. Also, the optical sheet 15 on the bottom of the display panel 10 may contact or be near the optical sheets 27 on the top of the backlight 20.

According to the present embodiment, the same effects as those of Embodiment 1 can be achieved. Further, the backlight 20 is fitted to the lower step of the stepped portion 2m formed within the recess 2a and the display panel 10 is fitted to the upper step of the stepped portion 2m. Therefore, the display panel 10 can be prevented from being mistakenly inserted into the lower step, which is narrower than the upper step of the stepped portion 2m, and thus the assembly of the display device 1 can be facilitated.

### Embodiment 4

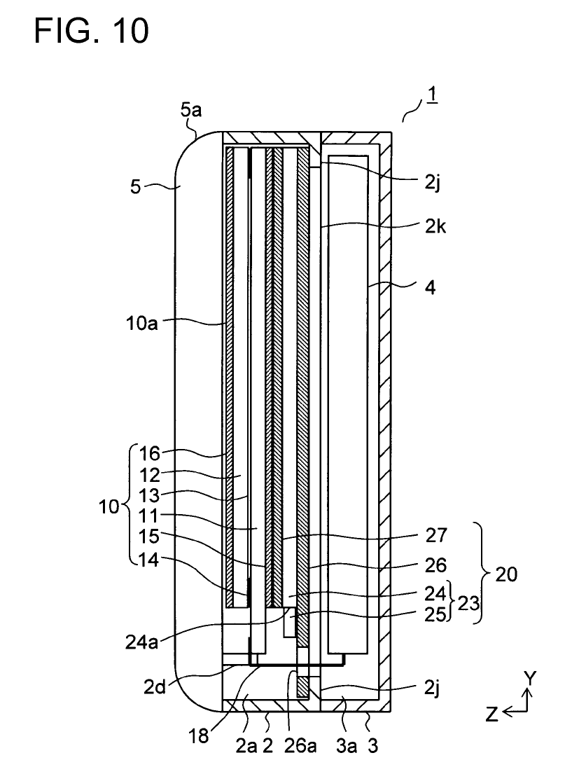

Next, FIG. 10 shows a side surface cross-sectional view of a display device 1 according to Embodiment 4. For the sake of explanation, portions that are identical to those in Embodiment 1 shown in FIGS. 1 to 7 will be assigned the same reference characters. In the present embodiment, the bottom surface of the recess 2a of the upper chassis 2 is opened and blocked by the reflective sheet 26. The other portions are identical to Embodiment 1.

In the recess 2a formed in the upper chassis 2, the bottom surface is opened and an opening 2k whose periphery is surrounded by mounting portions 2j that project from an inner peripheral wall of the recess 2a is formed. The reflective sheet 26 disposed in a lower layer of the backlight 20 is bridged between the opposing mounting portions 2j, and a bottom portion of the recess 2a is thereby blocked by the reflective sheet 26. An insertion hole 26a into which the lead wire 18 is inserted is also provided in the reflective sheet 26.

According to the present embodiment, the same effects as those of Embodiment 1 can be achieved. Further, since the upper chassis 2 has the opening 2k formed by opening the bottom surface of the recess 2a, the weight of the display device 1 can be reduced. Also, since the circuit substrate 4 and the like can be placed in the substrate accommodating portion 3a via the opening 2k, the number of parts of the display device 1 can be reduced by integrally molding the upper chassis 2 and the lower chassis 3 together.

In the present embodiment, the stepped portion 2m (refer to FIG. 9) may be provided within the recess 2a as in Embodiment 3.

### INDUSTRIAL APPLICABILITY

The present invention can be utilized in equipment such as a mobile terminal device (a mobile telephone, a tablet terminal, etc.) using an edge lit-type backlight.

### DESCRIPTION OF REFERENCE CHARACTERS

1 display device

2 upper chassis

2a recess

2c fitting groove

2j mounting portion

2m stepped portion

3 lower chassis

3a substrate accommodating portion

4 circuit substrate

5 transparent member

5a curved surface

6 imaging element

10 display panel

10a display surface

11 pixel substrate

12 opposite substrate

13 liquid crystal

14 seal

15, 16 optical sheet

17, 18 lead wire

20 backlight

23 light guide plate assembly

24 light guide plate

24a light-receiving face

24d light-exiting surface

25 light source

26 reflective sheet

27 optical sheet

29 projection

1: A display device, comprising:
a display panel;
a backlight that illuminates the display panel from a back surface thereof;
a chassis having an opened front surface defining a recess therein; and
a transparent member that covers the recess in the chassis,
wherein the display panel and the backlight are accommodated within the recess,
wherein the display panel and the backlight are horizontally positioned within respective planes parallel to a display surface of the display panel by being fitted into the recess, and
wherein the display panel and the backlight are vertically positioned in a direction perpendicular to the display surface of the display panel by a bottom surface of the recess and the transparent member.

2: The display device according to claim 1, wherein when the display surface is disposed facing upwards, the backlight contacts the bottom surface of the recess, the display panel contacts a top of the backlight, and a bottom of the transparent member is near or in contact with the display panel.

3: The display device according to claim 1, wherein the recess in the chassis has a stepped portion that is narrow on a back surface side thereof, the backlight is fitted to a lower level of the stepped portion, and the display panel is fitted to an upper level of the stepped portion.

4: The display device according to claim 1,
wherein the recess in the chassis has the bottom surface thereof open, and has mounting portions that project from inner peripheral walls thereof, and
wherein the backlight includes a reflective sheet that is bridged between the opposing mounting portions.

5: The display device according to claim 1, wherein the recess has, in a back surface side thereof, a substrate accommodating area that accommodates a circuit substrate for the display panel, and, in the bottom surface thereof, an insertion hole for a lead wire that connects the display panel to the circuit substrate.

6: The display device according to claim 1,
wherein the backlight includes a reflective sheet, a light guide plate, and an optical sheet,
wherein the display panel includes a pixel substrate,
wherein the chassis has grooves and ribs formed on respective side walls thereof, and
wherein the reflective sheet, the light guide plate, and the optical sheet each have projections that engage the grooves in the respective side walls of the chassis, and the pixel substrate engages the ribs of the chassis, thereby horizontally positioning the backlight and the display panel within the respective planes parallel to the display surface of the display panel.

7: The display device according to claim 2,
wherein the recess in the chassis has the bottom surface thereof open, and has mounting portions that project from inner peripheral walls thereof, and
wherein the backlight includes a reflective sheet that is bridged between the opposing mounting portions.

8: The display device according to claim 3,
wherein the recess in the chassis has the bottom surface thereof open, and has mounting portions that project from inner peripheral walls thereof, and
wherein the backlight includes a reflective sheet that is bridged between the opposing mounting portions.

9: The display device according to claim 2, wherein the recess has, in a back surface side thereof, a substrate accommodating area that accommodates a circuit substrate for the display panel, and, in the bottom surface thereof, an insertion hole for a lead wire that connects the display panel to the circuit substrate.

10: The display device according to claim 3, wherein the recess has, in a back surface side thereof, a substrate accommodating area that accommodates a circuit substrate for the display panel, and, in the bottom surface thereof, an insertion hole for a lead wire that connects the display panel to the circuit substrate.
